(19) United States
(12) Patent Application Publication
(10) Pub. No.: US 2024/0355114 A1
(43) Pub. Date: Oct. 24, 2024

(54) AREA CORRECTION DEVICE, AREA CORRECTION METHOD, AND PROGRAM

(71) Applicant: NIPPON TELEGRAPH AND TELEPHONE CORPORATION, Tokyo (JP)

(72) Inventors: Kazuaki WATANABE, Tokyo (JP); Yujin HAMANO, Tokyo (JP); Daisuke UCHIBORI, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/685,206

(22) PCT Filed: Aug. 26, 2021
(86) PCT No.: PCT/JP2021/031397

§ 371 Date: Feb. 20, 2024

(51) Int. Cl. G06V 10/98; G06V 10/22; G06V 10/24; G06V 10/30; G06V 10/44

(52) U.S. Cl. CPC G06V 10/98; G06V 10/22; G06V 10/24; G06V 10/30; G06V 10/44

(57) ABSTRACT

A region correction device (1) according to the present disclosure includes: an input unit (41) that receives an input of prediction region information indicating a prediction region (PA) indicating an image of a predetermined subject, the prediction region (PA) being detected from a captured image obtained by imaging the predetermined subject; a line segment extraction unit (42) that extracts a line segment on the basis of a contour of the prediction region (PA) indicated by the prediction region information; a correction unit (43) that corrects the prediction region (PA) on the basis of the line segment; and an output unit (44) that outputs corrected prediction region information indicating a corrected prediction region, the corrected prediction region being the prediction region (PA) that has been corrected.

### TECHNICAL FIELD

The present disclosure relates to a region correction device, a region correction method, and a program.

### BACKGROUND ART

When a conventional image analysis device detects regions (prediction regions PA) indicating images of predetermined subjects in an image by an image analysis method such as deep learning, erroneous detection occurs in some cases. For example, while regions (correct regions PAc) in a captured image corresponding to the regions in which predetermined subjects are present in the real space are as illustrated in FIG. 17A, an image analysis device might detect prediction regions PA as illustrated in FIG. 17B.

More specifically, as illustrated in FIG. 18A in which the portion of a rectangle RC1A in FIG. 17A is enlarged, the contours of the correct region PAc are formed with straight line segments. On the other hand, as illustrated in FIG. 18B in which the portion of a rectangle RC1B in FIG. 17B is enlarged, the contours of the prediction region PA are formed with connected lines that are shorter than the line segments of the correct region PAc while being shifted from one another. Also, as illustrated in FIG. 19A in which the portion of a rectangle RC2A in FIG. 17A is enlarged, the contours that define the correct regions PAc are formed with straight line segments. On the other hand, as illustrated in FIG. 19B in which the portion of a rectangle RC2B in FIG. 17B is enlarged, the contours of the prediction regions PA, particularly the rightmost one, is curved.

That is, as illustrated in FIG. 18B, the image analysis device might detect a portion that is not a correct region PAc as a prediction region PA, or might not detect a portion that is a correct region PAc as a prediction region PA. It is considered that such erroneous detection is caused by formation of images such as shadows in the portions corresponding to subjects in an image, depending on the light illuminating the subjects in the real space.

Non Patent Literature 1 discloses that the linearity of character lines shown on a paper surface is taken advantage of in correcting curvature distortion and tilting of character lines by fitting the character lines shown in a binarized image and a grayscale image scanned with a scanning device to a distortion model, with consistency on the entire paper surface being taken into consideration.

Meanwhile, Non Patent Literature 2 discloses that cracked portions of a concrete structure are detected from an image of the concrete structure as the subject on the basis of luminance values, and mold marks are identified on the basis of linearity of the cracked portions, to increase accuracy of detection of cracked portions.

### CITATION LIST

### Non Patent Literature

Non Patent Literature 1: Hironori EZAKI, and three others, “Dewarping of document image by global optimization”, Meeting on Image Recognition and Understanding (MIRU 2005), 2005
Non Patent Literature 2: Pang-jo Chun, and two others, “Gazo-kaiseki ni yoru hibiware kenshutsu to Hough-henkan ni yoru katawaku ato oyobi P-kon ato no dotei (in Japanese) (Crack detection by image analysis and identification of mold marks and plastic cone marks by Hough transformation)”, Proceedings of the Japan Concrete Institute, Vol. 37, No. 1, 2015

### SUMMARY OF INVENTION

### Technical Problem

However, by the technique disclosed in Non Patent Literature 1, it is necessary to correct the entire image, resulting in an increase in calculation cost. Furthermore, by the technique disclosed in Non Patent Literature 1, the shape of an image of a subject is distorted by correction of the entire image, and the position of the image of the subject in an image cannot be accurately detected.

Meanwhile, by the technique disclosed in Non Patent Literature 2, the line segments included in an image are detected, but the line segments included in the image are not corrected. Therefore, by the technique disclosed in Non Patent Literature 2, regions indicating images of subjects in an image cannot be detected with high accuracy, and, because of this, it is difficult to detect, with high accuracy, the regions in the image corresponding to the regions in which the predetermined subjects are present in the real space.

The present disclosure made in view of such circumstances aims to provide a region correction device, a region correction method, and a program capable of detecting, with high accuracy, regions in an image corresponding to the regions in which predetermined subjects are present in the real space.

### Solution to Problem

To solve the above problem, a region correction device according to the present disclosure includes: an input unit that receives an input of prediction region information indicating a prediction region indicating an image of a predetermined subject, the prediction region being detected from a captured image obtained by imaging the predetermined subject; a line segment extraction unit that extracts a line segment corresponding to a contour of the predetermined subject, on the basis of a contour of the prediction region indicated by the prediction region information; a correction unit that corrects the prediction region on the basis of the line segment; and an output unit that outputs corrected prediction region information indicating a corrected prediction region, the corrected prediction region being the prediction region that has been corrected.

Also, to solve the above problem, a region correction method according to the present disclosure includes: a step of receiving an input of prediction region information indicating a prediction region indicating an image of a predetermined subject, the prediction region being detected from an image obtained by imaging the predetermined subject; a step of extracting a line segment corresponding to a contour of the predetermined subject, on the basis of a contour of the prediction region indicated by the prediction region information; a step of correcting the prediction region on the basis of the line segment; and a step of outputting corrected prediction region information indicating a corrected prediction region obtained by correcting the prediction region.

Further, to solve the above problem, a program according to the present disclosure causes a computer to function as the above region correction device.

### Advantageous Effects of Invention

With a region correction device, a region correction method, and a program according to the present disclosure, it is possible to detect, with high accuracy, regions in an image corresponding to the regions in which predetermined subjects are present in the real space.

### BRIEF DESCRIPTION OF DRAWINGS

FIG. 1A is a schematic diagram of a region correction system according to a first embodiment.

FIG. 1B is a schematic diagram of a line segment extraction unit illustrated in FIG. 1A.

FIG. 1C is a schematic diagram of a correction unit illustrated in FIG. 1A.

FIG. 2 is a diagram illustrating an example of a captured image acquired by an image acquisition device illustrated in FIG. 1A.

FIG. 3 is a diagram illustrating an example of a binarized image showing prediction regions detected from the captured image illustrated in FIG. 2.

FIG. 4 is a diagram illustrating possible line segments detected from the binarized image illustrated in FIG. 3.

FIG. 5A is a diagram for explaining line segment extraction in a first example.

FIG. 5B is a diagram for explaining line segment extraction in a second example.

FIG. 5C is a diagram for explaining line segment extraction in a third example.

FIG. 5D is a diagram for explaining line segment extraction in a fourth example.

FIG. 6 is an enlarged view of a portion of the binarized image illustrated in FIG. 3.

FIG. 7A is a schematic diagram illustrating prediction regions and non-prediction regions in a portion of a binarized image.

FIG. 7B is a schematic diagram illustrating line segment pixels in a portion of the binarized image illustrated in the schematic diagram in FIG. 7A.

FIG. 8A is a schematic diagram illustrating a portion of a stored image in which the arrangement of peripheral pixels illustrated in FIG. 7B has been changed.

FIG. 8B is a schematic diagram showing a portion of a corrected image obtained by redetermining the peripheral pixels shown in FIG. 8A.

FIG. 9 is a sequence diagram illustrating an example operation in the region correction device illustrated in FIG. 1A.

FIG. 10 is a sequence diagram illustrating the details of a process of extracting line segments as illustrated in FIG. 9.

FIG. 11 is a sequence diagram illustrating the details of a process of correcting prediction regions as illustrated in FIG. 9.

FIG. 12A is a schematic diagram of a region correction system according to a second embodiment.

FIG. 12B is a schematic diagram of a transform unit illustrated in FIG. 12A.

FIG. 13A is a schematic diagram illustrating an image including respective images of a first subject and a second subject.

FIG. 13B is a schematic diagram illustrating a prediction region of the first subject illustrated in FIG. 13A.

FIG. 13C is a schematic diagram illustrating a closing prediction region obtained by performing a closing process on the prediction region illustrated in FIG. 13B.

FIG. 14 is a sequence diagram illustrating an example operation in the region correction device illustrated in FIG. 12A.

FIG. 15 is a sequence diagram illustrating the details of a process of transforming prediction region information as illustrated in FIG. 14.

FIG. 16 is a hardware block diagram of a region correction device.

FIG. 17A is a schematic diagram illustrating correct regions.

FIG. 17B is a schematic diagram illustrating prediction regions.

FIG. 18A is an enlarged view in which a portion of FIG. 17A is enlarged.

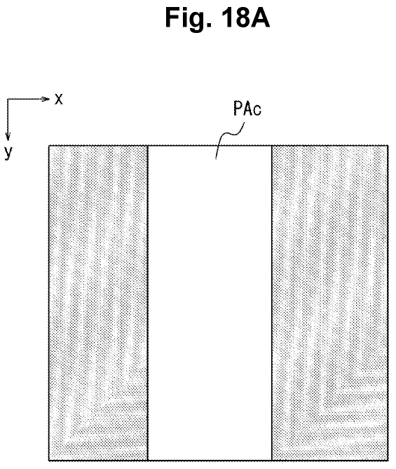

FIG. 18B is an enlarged view in which a portion of FIG. 17B is enlarged.

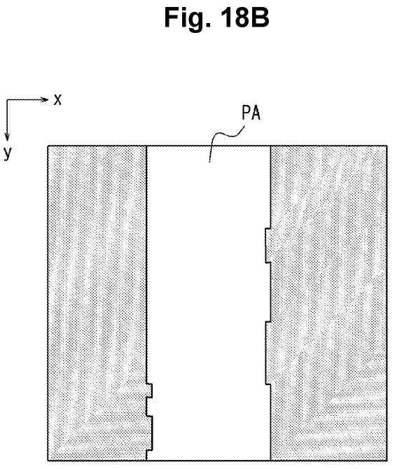

FIG. 19A is an enlarged view in which another portion of FIG. 17A is enlarged.

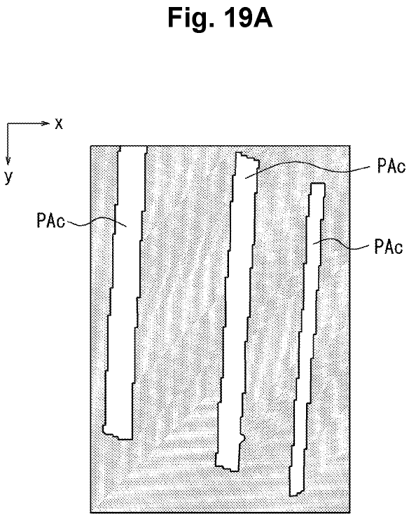

FIG. 19B is an enlarged view in which another portion of FIG. 17B is enlarged.

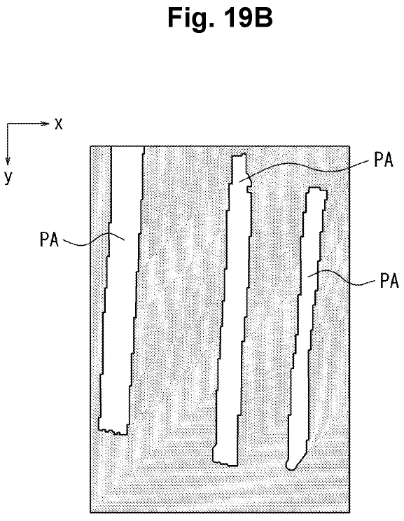

### DESCRIPTION OF EMBODIMENTS

### First Embodiment

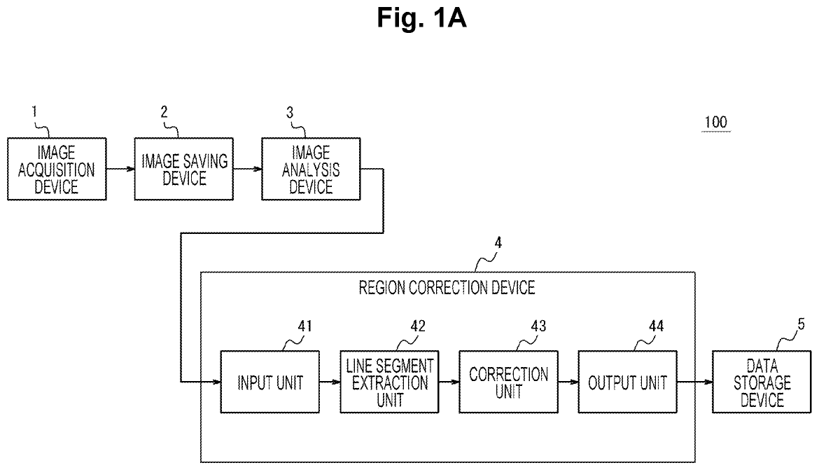

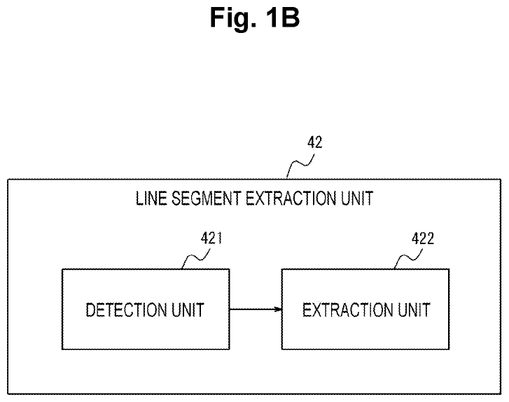

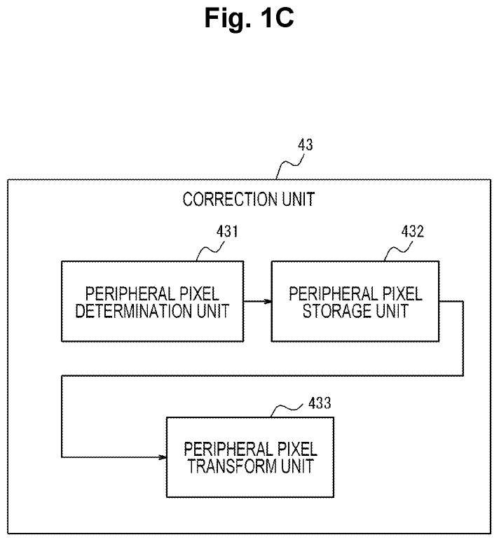

The overall configuration of a first embodiment is described below with reference to FIGS. 1A, 1B, and 1C.

As illustrated in FIG. 1A, a region correction system 100 according to the first embodiment includes an image acquisition device 1, an image saving device 2, an image analysis device 3, a region correction device 4, and a data storage device 5.

### <Configuration of the Image Acquisition Device>

The image acquisition device 1 may be formed with a camera including an optical element, an imaging element, and an output interface. The output interface is an interface for outputting an image captured by the imaging element.

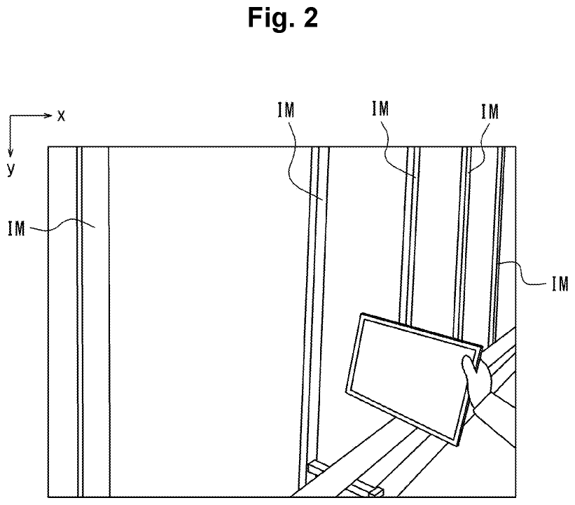

The image acquisition device 1 acquires a captured image obtained by imaging a subject as illustrated in FIG. 2. The captured image includes pixels two-dimensionally arranged in each of a predetermined direction (the y-axis direction in FIG. 2) and a direction orthogonal to the predetermined direction (the x-axis direction in FIG. 2). In the example in FIG. 2, a predetermined subject extends in the direction corresponding to the y-axis direction in the real space, and the captured image includes an image IM of the predetermined subject. Note that the predetermined direction and the orthogonal direction are the y-axis direction and the x-axis direction, respectively, also in an example of a diagram illustrating a binarized image based on a captured image to be referred to in the description below.

The predetermined subject can be a member to be inspected. Specifically, the predetermined subject can be a member of a structure, and, for example, can be a brace provided in a groove, a manhole, a handhole, or the like. In this embodiment, the contours of the subject are known, and are line segments, for example. The contours of the predetermined subject are known. The contours of the predetermined subject may be formed with line segments, for example. However, the contours of the predetermined subject are not limited to these, and may be formed with any appropriate lines. Note that, in the description below, an example in which the contours of the predetermined subject are line segments is described in detail.

The image acquisition device 1 also outputs the captured image to the image saving device 2.

### <Configuration of the Image Saving Device>

The image saving device 2 illustrated in FIG. 1A may be formed with a computer that includes a memory, a control unit (a controller), an input interface, and an output interface. The memory may be formed with memories such as a hard disk drive (HDD), a solid-state drive (SSD), an electrically erasable programmable read-only memory (EEPROM), a read-only memory (ROM), and a random access memory (RAM). The control unit may include dedicated hardware such as an application specific integrated circuit (ASIC) or a field-programmable gate array (FPGA), may include a processor, or may include both dedicated hardware and a processor. The input interface may be a pointing device, a keyboard, a mouse, or the like. Alternatively, the input interface may be an interface that accepts inputs of information received by a communications interface. For the communication interface, a standard such as Ethernet (registered trademark), fiber distributed data interface (FDDI), or Wi-Fi (registered trademark) may be used, for example.

The image saving device 2 stores the captured image acquired by the image acquisition device 1. The image saving device 2 also outputs the captured image to the image analysis device 3.

### <Configuration of the Image Analysis Device>

The image analysis device 3 may be formed with a computer that includes a memory, a control unit (a controller), an input interface, and an output interface.

The image analysis device 3 receives an input of the captured image saved by the image saving device 2. The image analysis device 3 then detects prediction regions PA in the captured image. A prediction region PA is a region detected as a region indicating an image of a predetermined subject in a captured image.

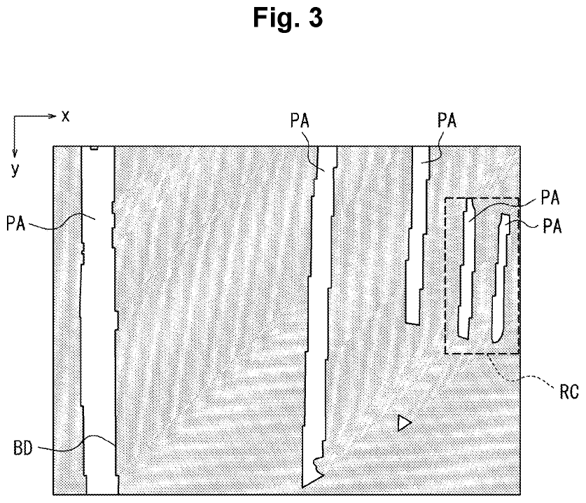

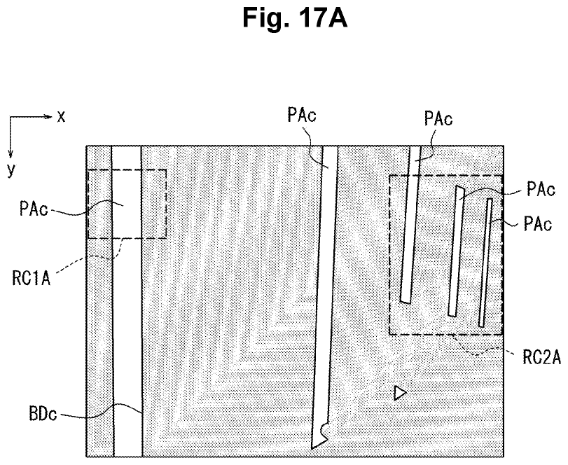

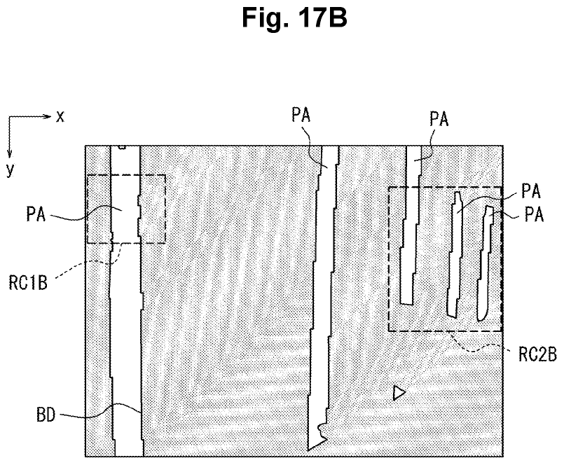

A prediction region PA has an error compared with a correct region PAc, due to a shadow formed by another object blocking the light illuminating the subject, for example. A correct region PAc is a region in a captured image corresponding to the region in which a predetermined subject is present in the real space. For example, a contour BDc of the correct region PAc in the example described with reference to FIG. 17A is a line segment extending from the upper end portion to the lower end portion of the binarized image indicating the correct region PAc. On the other hand, the line segment forming a contour BD of a prediction region PA in the example illustrated in FIG. 3 does not extend straight from the upper end portion to the lower end portion of the binarized image indicating the prediction region PA, but line segments shorter than the line segment indicating the contour BDc are joined while being shifted from one another.

The method for the image analysis device 3 to detect prediction regions PA can be any appropriate method. In an example, the image analysis device 3 can detect prediction regions PA by a method such as deep learning. Also, the image analysis device 3 can detect prediction regions PA by a method suitable for the subjects.

After detecting the prediction regions PA in the captured image, the image analysis device 3 outputs prediction region information indicating the positions of the prediction regions PA in the captured image, to the region correction device 4. The prediction region information may be a binarized image including pixels each determined to be either a prediction pixel included in a prediction region PA or a non-prediction pixel included in a non-prediction region that is not a prediction region PA. As illustrated in FIG. 3, prediction pixels may be indicated with a first color (white, for example) and non-prediction pixels may be indicated with a second color (black, for example). In the example in FIG. 3, the black color of the non-prediction pixels is indicated by halftone dots. Alternatively, the first color may be black, and the second color may be white. That is, the image analysis device 3 detects prediction regions in a captured image, determines that the pixels included in the prediction regions are prediction pixels, and determines that the pixels included in the non-prediction regions that are not prediction regions are non-prediction pixels. Thus, a binarized image indicating the prediction region information is generated.

### <Configuration of the Region Correction Device>

The region correction device 4 includes an input unit 41, a line segment extraction unit 42, a correction unit 43, and an output unit 44. The input unit 41 is formed with an input interface. The line segment extraction unit 42 and the correction unit 43 can constitute a control unit, and the output unit 44 is formed with an output interface.

The input unit 41 receives an input of the prediction region information indicating the prediction regions PA indicating images of predetermined subjects, the prediction regions PA having being detected from a captured image obtained by imaging the predetermined subjects. The input unit 41 receives an input of the prediction region information output by the image analysis device 3.

The line segment extraction unit 42 extracts line segments on the basis of the contours of the prediction regions PA indicated by the prediction region information. For example, the line segment extraction unit 42 extracts a plurality of possible line segments on the basis of the contours, and extracts line segments from the plurality of possible line segment on the basis of any one or more of the distance to another possible line segment from each line segment of the plurality of possible line segments, the length of each line segment of the plurality of possible line segments, the extending direction of each line segment of the plurality of possible line segments, and the presence/absence of an intersection between each line segment of the plurality of possible line segments and another possible line segment.

The line segment extraction unit 42 includes a detection unit 421 and an extraction unit 422.

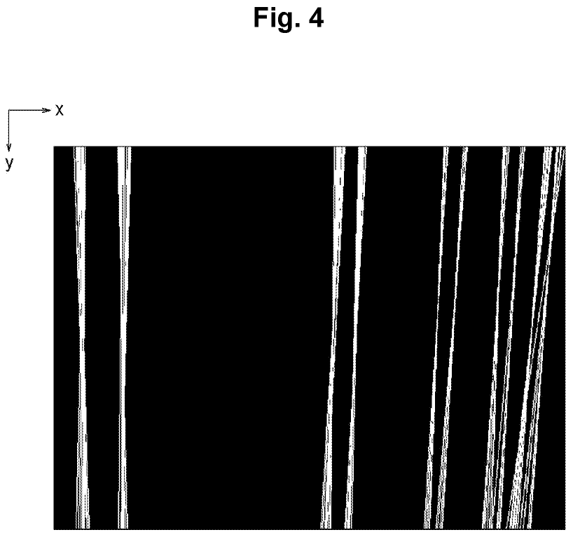

The detection unit 421 detects possible line segments on the basis of the contours of the prediction regions PA indicated by the prediction region information input by the input unit 41. Specifically, the detection unit 421 detects, as possible line segments, line segments that minimize an error from each line of a plurality of lines that are joined and have deviations smaller than a threshold in the contours of the prediction regions PA indicated by the binarized image that is the prediction region information. At this point of time, due to the fact that the contours of the prediction regions PA do not extend straight, as illustrated in FIG. 4, a plurality of possible line segments might be detected from one contour of one prediction region PA (see FIG. 3). In FIG. 4, possible line segments are indicated by white lines, and FIG. 4 illustrates a plurality of thin white lines that are arranged at short distances from each other, and overlap or intersect each other.

The extraction unit 422 extracts line segments corresponding to the contours of the prediction regions PA to be used in the correction by the correction unit 43, from the plurality of possible line segments detected by the detection unit 421 as illustrated in FIG. 4.

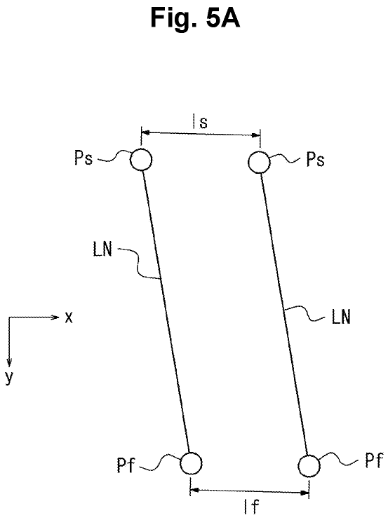

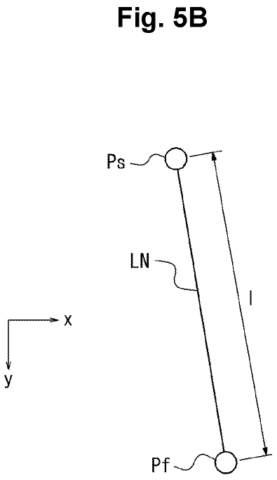

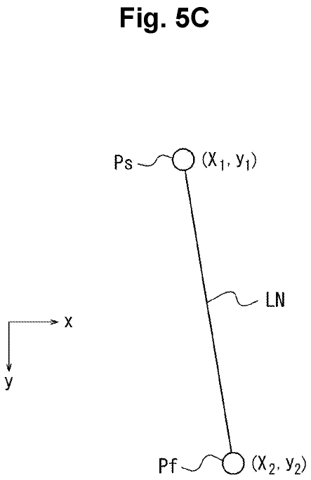

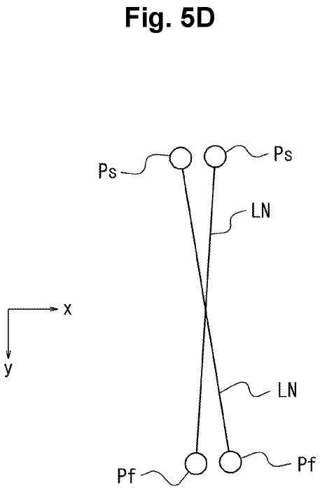

Here, first to fourth examples of processes to be performed by the extraction unit 422 to extract line segments from possible line segments LN are described in detail with reference to FIGS. 5A to 5D.

In the first example, the extraction unit 422 extracts a line segment, on the basis of the distance between each line segment of a plurality of possible line segments LN detected by the detection unit 421 and another possible line segment LN. For example, in a case where the distance between each of the possible line segments LN and another possible line segment LN is equal to or shorter than a predetermined distance, the extraction unit 422 extracts only one of the possible line segments LN as a line segment.

Specifically, as illustrated in FIG. 5A, the extraction unit 422 selects two possible line segments LN from a plurality of possible line segments LN detected by the detection unit 421. The extraction unit 422 then calculates a distance ls between starting points, which is a distance between one end point (a starting point Ps) of one possible line segment LN of the two possible line segments LN and one end point (a starting point Ps) of the other possible line segment LN. The starting point Ps of the other possible line segment LN is the end point closer to the starting point Ps of the one possible line segment LN, of the end points of the other possible line segment LN. The extraction unit 422 also calculates a distance lf between end points, which is a distance between the other end point (a finishing point Pf) of the one possible line segment LN and the other end point (a finishing point Pf) of the other possible line segment LN, of the two possible line segments LN. The finishing point Pf of the other possible line segment is the end point closer to the finishing point Pf of the one line segment, of the end points of the other possible line segment LN.

The extraction unit 422 then determines whether each of the distance ls between the starting points and the distance lf between the finishing points is equal to or shorter than a predetermined distance. When determining that each of the distance ls between the starting points and the distance lf between the finishing points is equal to or shorter than the predetermined distance, the extraction unit 422 extracts only one of the possible line segments LN as a line segment. When determining that either the distance ls between the starting points or the distance lf between the finishing points is longer than the predetermined distance, on the other hand, the extraction unit 422 extracts both of the possible line segments LN as line segments.

In the second example, the extraction unit 422 calculates the length 1 of each line segment of a plurality of possible line segments LN detected by the detection unit 421, as illustrated in FIG. 5B. The extraction unit 422 then determines whether the length 1 is equal to or longer than a predetermined length for each line segment of the plurality of possible line segments LN. The predetermined length can be a length corresponding to the subject as the target for detecting the prediction region PA. When determining that the length 1 is equal to or longer than the predetermined length, the extraction unit 422 extracts the possible line segment LN having the length 1 as a line segment. When determining that the length 1 is shorter than the predetermined length, the extraction unit 422 does not extract the possible line segment LN having the length l as a line segment.

Note that, in the second example, the extraction unit 422 may first determine whether both end portions of each line segment of the plurality of possible line segments LN are located at both end portions (the upper end portion and the lower end portion) of the binarized image. The extraction unit 422 may then calculate the length 1 of the possible line segment LN having both end portions not located at the end portions of the binarized image, and determine whether the length 1 is equal to or longer than the predetermined length.

In the third example, the extraction unit 422 extracts a line segment from a plurality of possible line segments LN, on the basis of the extending direction of each line segment of a plurality of possible line segments LN detected by the detection unit 421. For example, the extraction unit 422 may extract a line segment from the plurality of possible line segments LN, on the basis of an acute angle formed with respect to the y-axis direction in the extending direction of each line segment of the plurality of possible line segments LN.

For example, for each possible line segment LN, the extraction unit 422 may determine that the extending direction of the possible line segment LN forms an angle equal to or smaller than a predetermined angle with respect to the y-axis direction, on the basis of a first distance and a second distance. The first distance is a distance between the starting point Ps and the finishing point Pf of the possible line segment LN in the x-axis direction. The second distance is a distance between the starting point Ps and the finishing point Pf in the y-axis direction.

Specifically, the extraction unit 422 calculates a distance (an x-axis direction distance) in the x-axis direction between the starting point Ps and the finishing point Pf of the possible line segment LN. The extraction unit 422 also calculates a distance (a y-axis direction distance) in the y-axis direction between the starting point Ps and the finishing point Pf of each possible line segment LN. As illustrated in FIG. 5C, in the example in which the coordinates of the starting point Ps of a possible line segment LN are (x1, y1), and the coordinates of the finishing point Pf of the possible line segment LN are (x2, y2), the extraction unit 422 calculates an orthogonal-direction distance as | x1−x2|, and calculates a predetermined-direction distance as | y1−y2|.

The extraction unit 422 then determines whether the y-axis direction distance is equal to or longer than the x-axis direction distance. When determining that the y-axis direction distance is equal to or longer than the x-axis direction distance, the extraction unit 422 extracts the possible line segment LN as a line segment. When determining that the y-axis direction distance is shorter than the x-axis direction distance, the extraction unit 422 does not extract the possible line segment LN as a line segment.

In the fourth example, as illustrated in FIG. 5D, the extraction unit 422 determines whether the line segments of a plurality of possible line segments LN detected by the detection unit 421 intersect with each other. When determining that the line segments of the plurality of possible line segments LN intersect with each other, the extraction unit 422 extracts one possible line segment LN as a line segment from the plurality of possible line segments LN. When determining that the line segments of the plurality of possible line segments LN do not intersect with each other, on the other hand, the extraction unit 422 extracts each line segment of the plurality of possible line segments LN as a line segment. Also, the extraction unit 422 may calculate an average value of the slopes and an average value of the intercepts of the plurality of possible line segments LN intersecting with each other, and extract a line segment having the average values as its slope and intercept.

The correction unit 43 corrects the prediction regions PA, on the basis of the line segments extracted by the line segment extraction unit 42. Specifically, the correction unit 43 corrects the binarized image, on the basis of the positions of line segment pixels indicating the line segments extracted by the line segment extraction unit 42, and the prediction pixels and the non-prediction pixels. More specifically, the correction unit 43 moves a predetermined number of peripheral pixels located adjacent to line segment pixels in an orthogonal direction, in a direction orthogonal to a predetermined direction so that the line segment pixels are aligned in a line in the predetermined direction. On the basis of the number of prediction pixels and the number of non-prediction pixels forming the peripheral pixels, the correction unit 43 then corrects the binarized image by redetermining the respective peripheral pixels to be prediction pixels and non-prediction pixels.

The correction unit 43 includes a peripheral pixel determination unit 431, a peripheral pixel storage unit 432, and a peripheral pixel transform unit 433.

The peripheral pixel determination unit 431 determines peripheral pixels, on the basis of the prediction region information whose input has been received by the input unit 41, and the line segments extracted by the line segment extraction unit 42. Specifically, the peripheral pixel determination unit 431 determines the number n of peripheral pixels, on the basis of the prediction region information. The peripheral pixel determination unit 431 then determines peripheral pixels, on the basis of line segment pixels indicating the line segments and the number n of peripheral pixels.

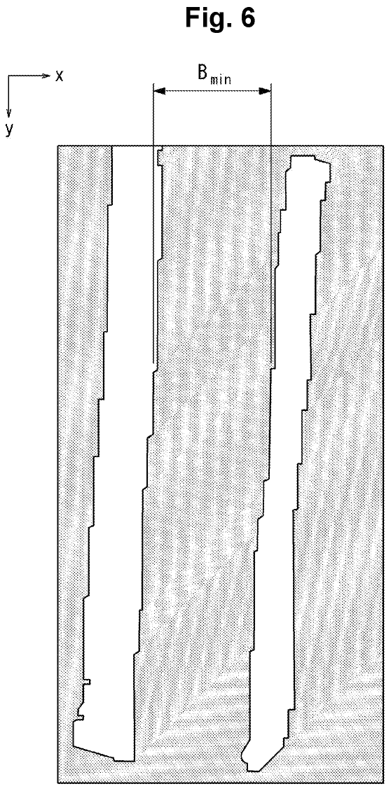

The number n of peripheral pixels (pixels) (n being an odd number) is expressed by Expression (1). Bₘᵢₙ shown in Expression (1) can be the minimum width of a prediction region PA having a width equal to or greater than a predetermined width in the binarized image. Also, as illustrated in FIG. 6, Bₘᵢₙ can also be set to the minimum number of pixels in the x-axis direction between the prediction region PA having a predetermined area or larger and the smallest area and the prediction region PA having the next smallest area in the binarized image. FIG. 6 is an enlarged view of a rectangle RC shown in FIG. 3. Further, Bₘᵢₙ can also be set to the minimum number of pixels in the x-axis direction between the prediction region PA having the shortest length in the y-axis direction and the prediction region PA having the next shortest length in the y-axis direction in the binarized image.

$$n \leq {B}_{min} \qquad ( 1 )$$

By determining the number n of peripheral pixels in this manner, the peripheral pixel transform unit 433 described later can redetermine whether each peripheral pixel is a prediction pixel or a non-prediction pixel, and thus reduce the influence on the pixels constituting the other prediction regions PA in the binarized image at a time of correction of the binarized image. Accordingly, erroneous correction can be reduced.

The peripheral pixel determination unit 431 determines the number n of peripheral pixels, on the basis of Expression (1). The peripheral pixel determination unit 431 then determines that n pixels arranged adjacent to the line segment pixels in the +x-axis direction and the −x-axis direction are peripheral pixels. The line segment pixels are the pixels indicating the line segments extracted by the line segment extraction unit 42. Specifically, for each y-coordinate, when the x-coordinate of a line segment pixel is xₖ, the peripheral pixel determination unit 431 determines that the pixels whose x-coordinates are located from xₖ+1 to xₖ+1+n, and the pixels whose x-coordinates are located from xₖ−1−n to xₖ−1 are peripheral pixels.

The peripheral pixel storage unit 432 stores the peripheral pixels. Specifically, the peripheral pixel storage unit 432 moves the peripheral pixels at the respective y-coordinates in the x-axis direction so that the line segments extend in the y-axis direction, and thus redetermines each of the peripheral pixels to be either a prediction pixel or a non-prediction pixel.

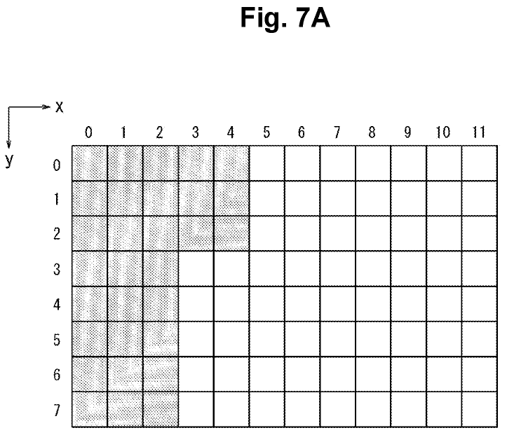

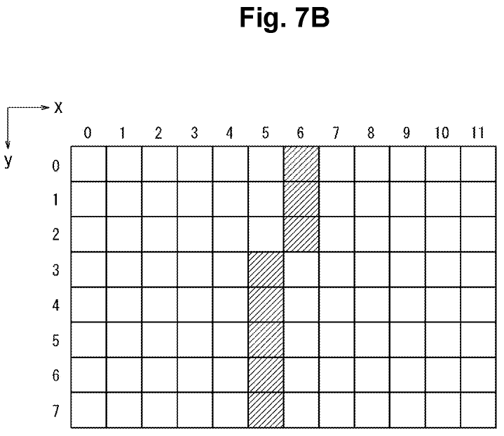

In an example illustrated in FIG. 7A, the pixels located from coordinates (0, 0) to coordinates (4, 2), and the pixels located from coordinates (0, 3) to coordinates (2, 7) are non-prediction pixels, and the region formed with the non-prediction pixels is a non-prediction region. Further, the pixels located from coordinates (5, 0) to coordinates (11, 2), and the pixels located from coordinates (3, 3) to coordinates (11, 7) are prediction pixels, and the region formed with the prediction pixels is a prediction region PA. Furthermore, in this example, as illustrated in FIG. 7B, the pixels located from coordinates (6, 0) to coordinates (6, 2), and the pixels located from coordinates (5, 3) to coordinates (5, 7) are line segment pixels (the hatched pixels in FIG. 7B).

Specifically, the peripheral pixel storage unit 432 moves the peripheral pixels so that the line segment pixels are aligned in a line in the y-axis direction, and the arrangement sequence of the prediction pixels and the non-prediction pixels in the x-axis direction is not changed. In this manner, the peripheral pixel storage unit 432 generates a stored image in which the peripheral pixels have been moved in the binarized image.

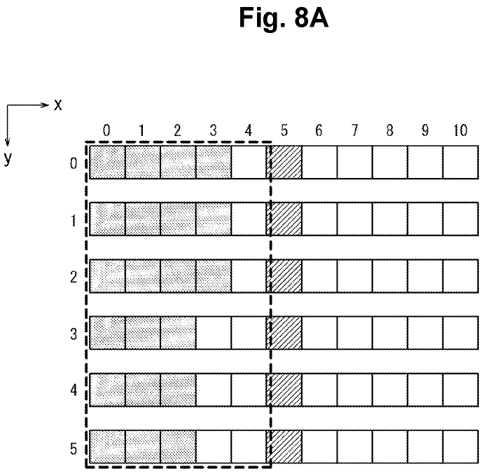

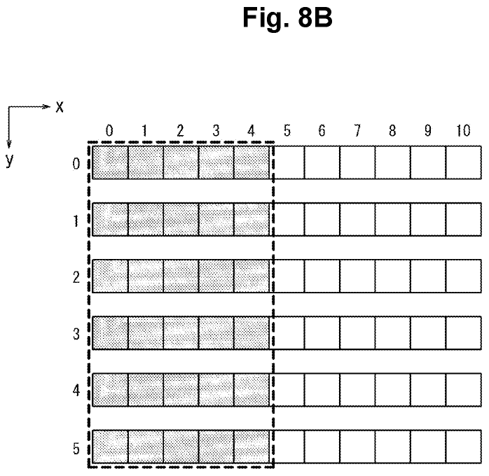

Referring to an example illustrated in FIGS. 7B and 8A, the peripheral pixel storage unit 432 moves the peripheral pixels illustrated in FIG. 7B so that the respective line segment pixels at y-coordinates 0 to 5 are aligned in a line in the y-axis direction, and the arrangement sequence of the prediction pixels and the non-prediction pixels in the x-axis direction is not changed, as illustrated in FIG. 8A. More specifically, the peripheral pixel storage unit 432 changes the arrangement of the peripheral pixels by moving the respective pixels whose y-coordinates are 0 in the −x-axis direction by the amount equivalent to one pixel so that the line segment pixel located at coordinates (6, 0) in FIG. 7B is located at coordinates (5, 0) in FIG. 8A. Likewise, the peripheral pixel storage unit 432 changes the arrangement of the peripheral pixels by moving the respective pixels whose y-coordinates are 1 in the −x-axis direction by the amount equivalent to one pixel so that the line segment pixel located at coordinates (6, 1) in FIG. 7B is located at coordinates (5, 1) in FIG. 8A. Likewise, the peripheral pixel storage unit 432 changes the arrangement of the peripheral pixels by moving the respective pixels whose y-coordinates are 2 in the −x-axis direction by the amount equivalent to one pixel so that the line segment pixel located at coordinates (6, 2) in FIG. 7B is located at coordinates (5, 2) in FIG. 8A. In this example, the peripheral pixel storage unit 432 does not move the respective pixels located at y-coordinates 3 to 7. As a result, in the correction region including line segment pixels and peripheral pixels, the pixels are arranged so that the line segment pixels are aligned in a line in the y-axis direction.

As illustrated in FIG. 8B, the peripheral pixel transform unit 433 redetermines that the peripheral pixels in the stored image stored by the peripheral pixel storage unit 432 are prediction pixels or non-prediction pixels, and thus generates a corrected image indicating the corrected prediction region obtained by correcting the prediction region PA. Specifically, on the basis of the number of non-prediction pixels and the number of prediction pixels among the peripheral pixels on each side in the x-axis direction of the line segment pixels, the peripheral pixel transform unit 433 redetermines that the peripheral pixels on each side are prediction pixels or non-prediction pixels, and generates corrected prediction region information indicating the corrected prediction region formed with the redetermined prediction pixels.

More specifically, the peripheral pixel transform unit 433 determines, for each y-coordinate, whether the number of prediction pixels is equal to or larger than the number of non-prediction pixels, among the peripheral pixels on the +x-axis direction side of the line segment pixels. When determining that the number of prediction pixels is equal to or larger than the number of non-prediction pixels, the peripheral pixel transform unit 433 then redetermines that all the peripheral pixels on the +x-axis direction side at the y-coordinate are prediction pixels. When determining that the number of prediction pixels is smaller than the number of non-prediction pixels, the peripheral pixel transform unit 433 redetermines that all the peripheral pixels on the +x-axis direction side at the y-coordinate are non-prediction pixels. Likewise, the peripheral pixel transform unit 433 determines, for each y-coordinate, whether the number of prediction pixels is equal to or larger than the number of non-prediction pixels, among the peripheral pixels on the −x-axis direction side of the line segment pixels. When determining that the number of prediction pixels is equal to or larger than the number of non-prediction pixels, the peripheral pixel transform unit 433 then redetermines that all the peripheral pixels on the −x-axis direction side at the y-coordinate are prediction pixels. When determining that the number of prediction pixels is smaller than the number of non-prediction pixels, the peripheral pixel transform unit 433 redetermines that all the peripheral pixels on the −x-axis direction side at the y-coordinate are non-prediction pixels.

In the example illustrated in FIG. 8A, the number of prediction pixels is five, and the number of non-prediction pixels is zero, among the peripheral pixels located from coordinates (6, 0) to coordinates (10, 0) on the +x-axis direction side of the line segment pixel located at coordinates (5, 0). Accordingly, the peripheral pixel transform unit 433 determines that the number of prediction pixels is larger than the number of non-prediction pixels. As illustrated in FIG. 8B, the peripheral pixel transform unit 433 then redetermines that the peripheral pixels located from coordinates (6, 0) to coordinates (10, 0) on the +x-axis direction side of the line segment pixel are prediction pixels (remain prediction pixels). Also, the number of prediction pixels is one, and the number of non-prediction pixels is four, among the peripheral pixels located from coordinates (0, 0) to coordinates (4, 0) on the −x-axis direction side of the line segment pixel located at coordinates (5, 0). Accordingly, the peripheral pixel transform unit 433 determines that the number of prediction pixels is smaller than the number of non-prediction pixels. The peripheral pixel transform unit 433 then redetermines that all the peripheral pixels located from coordinates (0, 0) to coordinates (4, 0) on the −x-axis direction side of the line segment pixel are non-prediction pixels. That is, the peripheral pixel transform unit 433 leaves the peripheral pixels located from coordinates (0, 0) to coordinates (3, 0) as non-prediction pixels, and changes the peripheral pixel located at coordinates (4, 0) to a non-prediction pixel. The peripheral pixel transform unit 433 also redetermines the peripheral pixels at the y-coordinates 1 to 5 in the same manner. As a result, the peripheral pixel transform unit 433 generates corrected prediction region information indicating a corrected prediction region that is the prediction region PA formed with the redetermined prediction pixels.

After redetermining the peripheral pixels at the respective y-coordinates, the peripheral pixel transform unit 433 may redetermine peripheral pixels in the same manner, on the basis of the number of prediction pixels and the number of non-prediction pixels in a predetermined number of rows adjacent to each other in the y-axis direction. For example, in a case where the number of prediction pixels is larger than the number of non-prediction pixels among the peripheral pixels in the predetermined number of rows arranged adjacent to each other, the peripheral pixel transform unit 433 may redetermine that the peripheral pixels in the predetermined number of rows are prediction pixels. In a case where the number of non-prediction pixels is larger than the number of prediction pixels among the peripheral pixels in a predetermined number of rows arranged adjacent to each other in such a configuration, for example, the peripheral pixel transform unit 433 may redetermine that the peripheral pixels in the predetermined number of rows are prediction pixels. Note that, in this example, the “predetermined number” as in the predetermined number of rows is an odd number.

Note that, in the example described above, the peripheral pixel transform unit 433 transforms the n peripheral pixels located on the +x-axis direction side of the line segment pixel and the n peripheral pixels located on the −x-axis direction side, but embodiments are not limited to this example. For example, the peripheral pixel transform unit 433 may redetermine whether each of the c (c<n) peripheral pixels located on the +x-axis direction side of the line segment pixel and the c peripheral pixels located on the −x-axis direction side is a prediction pixel or a non-prediction pixel. By redetermining whether the c peripheral pixels (c being smaller than n) are prediction pixels or non-prediction pixels in this manner, it is possible to reduce erroneous correction of pixels in a region that does not need to be corrected.

The output unit 44 outputs the corrected prediction region information indicating the corrected prediction region that is the prediction region PA corrected by the correction unit 43. Specifically, the output unit 44 may output the corrected prediction region information to the data storage device 5 via a communication network. The output unit 44 may output the corrected prediction region information to a display device formed with an organic electro-luminescence (EL), a liquid crystal panel, or the like.

### <Configuration of the Data Storage Device>

The data storage device 5 illustrated in FIG. 1A is formed with a computer that includes a memory, a control unit, and an input interface. The data storage device 5 stores the corrected prediction region information output from the region correction device 4.

### <Operation of the Region Correction Device>

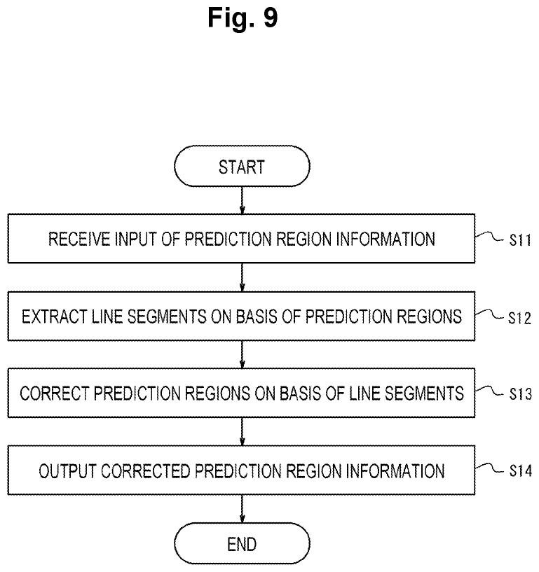

Here, an operation of the region correction device 4 according to the first embodiment is described with reference to FIG. 9. FIG. 9 is a flowchart illustrating an example operation of the region correction device 4 according to the first embodiment. The operation in the region correction device 4 to be described with reference to FIG. 9 corresponds to an example of a region correction method for the region correction device 4 according to the first embodiment.

In step S11, the input unit 41 receives an input of prediction region information indicating prediction regions PA indicating images of predetermined subjects, the prediction regions PA having being detected from a captured image obtained by imaging the predetermined subjects. Specifically, the input unit 41 receives an input of the prediction region information output by the image analysis device 3.

In step S12, the line segment extraction unit 42 extracts line segments on the basis of the contours of the prediction regions PA indicated by the prediction region information.

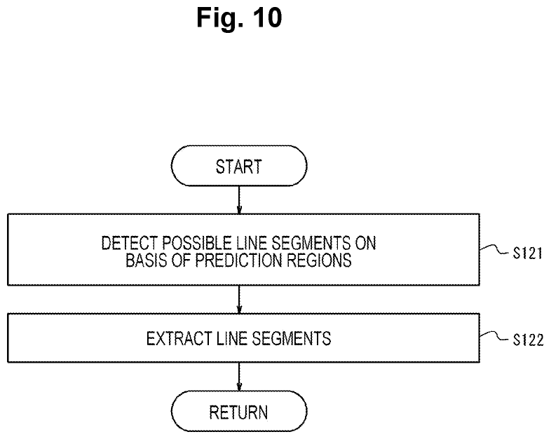

Here, the line segment extraction to be performed by the line segment extraction unit 42 in step S12 is described in detail, with reference to FIG. 10.

In step S121, the detection unit 421 extracts possible line segments LN on the basis of the contours of the prediction regions PA indicated by the prediction region information.

In step S122, the extraction unit 422 extracts the line segments corresponding to the contours of the predetermined subjects from the plurality of possible line segments LN detected in step S121.

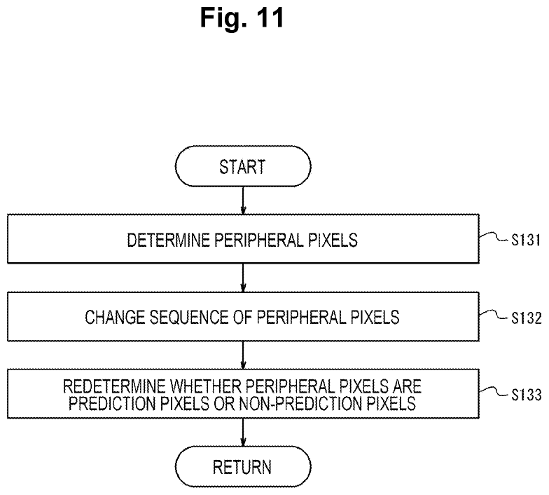

Referring back to FIG. 9, in step S13, the correction unit 43 corrects the prediction regions PA on the basis of the line segments extracted in step S12. Here, the correction to be performed by the correction unit 43 in step S13 is described in detail, with reference to FIG. 11.

In step S131, the peripheral pixel determination unit 431 determines peripheral pixels, on the basis of the prediction region information whose input has been received by the input unit 41, and the line segments extracted by the line segment extraction unit 42.

In step S132, the peripheral pixel storage unit 432 stores the peripheral pixels.

In step S133, the peripheral pixel transform unit 433 redetermines whether the peripheral pixels stored in step S132 are prediction pixels or non-prediction pixels.

Referring back to FIG. 9, in step S14, the output unit 44 outputs corrected prediction region information indicating the corrected prediction regions obtained by correcting the prediction regions PA in step S13.

As described above, according to the first embodiment, the region correction device 4 includes: the line segment extraction unit 42 that extracts line segments on the basis of the contours of a prediction region PA indicated by prediction region information; the correction unit 43 that corrects the prediction region PA on the basis of the line segments; and the output unit 44 that outputs corrected prediction region information indicating a corrected prediction region obtained by correcting the prediction region PA. With this configuration, the region correction device 4 can detect, with high accuracy, regions in a captured image corresponding to the regions in which predetermined subjects are present in the real space. The region correction device 4 can also detect, with high accuracy, the regions in the captured image, without an increase in the calculation cost.

Also, according to the first embodiment, the region correction device 4 may extract a plurality of possible line segments LN on the basis of the contours, and extract line segments on the basis of a distance between each line segment of the plurality of possible line segments LN and another possible line segment LN. For example, in a case where the distance between each of the possible line segments LN and another possible line segment LN is equal to or shorter than a predetermined distance, the region correction device 4 may extract only one of the possible line segments LN as a line segment. As a result, even in a case where an error is included in the binarized image that is the prediction region information generated by the image analysis device 3, and a plurality of line segments is detected due to the error, the region correction device 4 can extract only one line segment that should be originally detected. Accordingly, the region correction device 4 can correct the prediction regions PA with high accuracy, and thus, can detect, with higher accuracy, the regions in the captured image corresponding to the regions in which the predetermined subjects are present in the real space.

Further, according to the first embodiment, the region correction device 4 may extract a plurality of possible line segments LN on the basis of the contours, and extract line segments from the plurality of possible line segments LN on the basis of the length of each line segment of the plurality of possible line segments LN. For example, the region correction device 4 may determine whether the length of each line segment of the plurality of possible line segments LN is equal to or shorter than a predetermined length, and, when determining that the length is equal to or longer than the predetermined length, may extract the possible line segments LN having the length as line segments. As a result, in a case where an error is included in the binarized image that is the prediction region information generated by the image analysis device 3, and line segments are erroneously detected due to the error, the region correction device 4 does not extract the line segments having smaller lengths than the predetermined length considered to be highly likely to be erroneously detected. In this manner, the region correction device 4 can appropriately extract line segments. Accordingly, the region correction device 4 can correct the prediction regions PA with high accuracy, and thus, can detect, with higher accuracy, the regions in the captured image corresponding to the regions in which the predetermined subjects are present in the real space.

Furthermore, according to the first embodiment, the region correction device 4 may extract a plurality of possible line segments LN on the basis of the contours, and extract line segments from the plurality of possible line segments LN on the basis of the extending direction of each line segment of the plurality of possible line segments LN. For example, the region correction device 4 may extract, as a line segment, a possible line segment LN whose acute angle with respect to the y-axis direction in the extending direction is equal to or smaller than a predetermined angle, and may not extract, as a line segment, a possible line segment LN whose acute angle with respect to the y-axis direction in the extending direction is greater than the predetermined angle. In an example in which a predetermined subject extending in the direction corresponding to the y-axis direction is set as an inspection target in the real space, a line segment indicating a contour of an image of the subject is expected to extend in the y-axis direction. Therefore, in a case where the acute angle of the line segment whose extending direction with respect to the y-axis direction is greater than a predetermined angle, there may be a high possibility of erroneous detection of the line segment. Thus, the region correction device 4 can correct prediction regions PA with high accuracy by not extracting, as a correction target, any line segment that is likely to be erroneously detected. Because of this, the region correction device 4 can detect, with higher accuracy, regions in a captured image corresponding to the regions in which the predetermined subjects are present in the real space.

Further, according to the first embodiment, the region correction device 4 may extract a plurality of possible line segments LN on the basis of the contours, and extract line segments from the plurality of possible line segments LN on the basis of presence/absence of an intersection in the plurality of possible line segments LN. For example, the region correction device 4 may extract one possible line segment LN among a plurality of possible line segments LN as a line segment when determining that the possible line segments LN intersect with each other, and may extract each line segment of a plurality of possible line segments LN as a line segment when determining that the possible line segments LN do not intersect with each other. It is expected that the line segments indicating the contours of a prediction region PA in a captured image obtained by imaging a predetermined subject do not intersect with each other. Therefore, in a case where line segments intersect with each other, there may be a high possibility that the plurality of line segments has been erroneously detected. Thus, the region correction device 4 can correct prediction regions PA with high accuracy by not extracting, as a line segment, any possible line segment LN that is likely to be erroneously detected. Because of this, the region correction device 4 can detect, with higher accuracy, regions in a captured image corresponding to the regions in which the predetermined subjects are present in the real space.

### (Modifications)

Note that, in the first embodiment described above, the region correction device 4 may store beforehand correct region information indicating correct regions PAc in a captured image. In such a configuration, the region correction device 4 may extract line segments only from the vicinities of the contours of the correct regions PAC indicated by the correct region information. By doing so, the region correction device 4 can more efficiently detect the line segments corresponding to the contours of prediction regions PA.

Also, in the first embodiment described above, the prediction region information output by the image analysis device 3 may not be a binarized image, but may be an image other than a binarized image, such as a grayscale image. In such a configuration, the region correction device 4 may include a binarized image generation unit. The binarized image generation unit generates a binarized image by binarizing an image that is not a binarized image but is prediction region information output from the image analysis device 3 and received as an input by the input unit 41. The line segment extraction unit 42 then performs the process as described above, using the binarized image generated by the binarized image generation unit.

### Second Embodiment

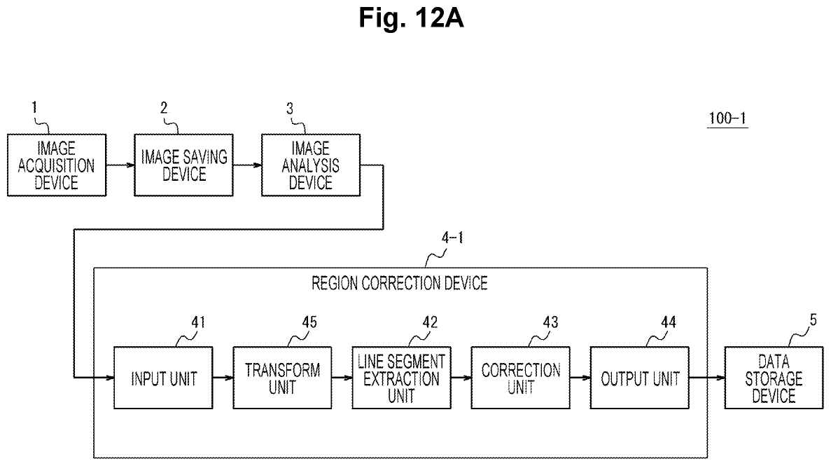

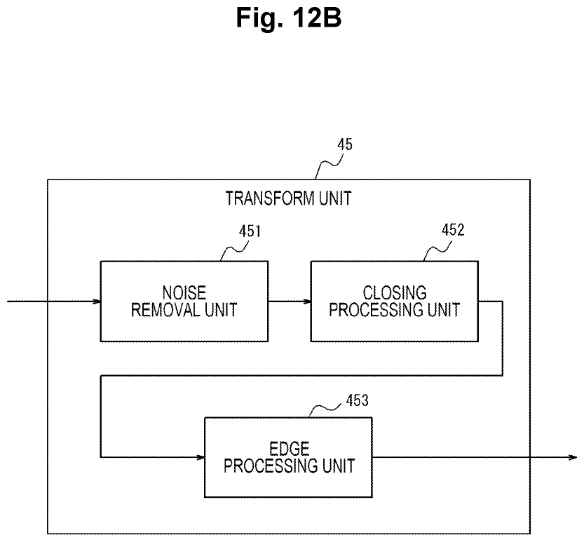

Referring now to FIGS. 12A and 12B, an overall configuration of a second embodiment is described. In the second embodiment, the same functional units as those in the first embodiment are denoted by the same reference numerals, and explanation thereof will not be repeated.

As illustrated in FIG. 12A, a region correction system 100-1 according to the second embodiment includes an image acquisition device 1, an image saving device 2, an image analysis device 3, a region correction device 4-1, and a data storage device 5.

### <Configuration of the Region Correction Device>

The region correction device 4-1 includes an input unit 41, a line segment extraction unit 42, a correction unit 43, an output unit 44, and a transform unit 45. The transform unit 45 forms a control unit.

The transform unit 45 transforms prediction region information received as an input by the input unit 41. As illustrated in FIG. 12B, the transform unit 45 includes a noise removal unit 451, a closing processing unit 452, and an edge processing unit 453.

The noise removal unit 451 removes noise included in the prediction region information received as an input by the input unit 41. Noise is minute non-prediction regions included in prediction regions PA, or minute prediction regions PA included in non-prediction regions. A minute non-prediction region may be a non-prediction region having a predetermined area or smaller, or may be a non-prediction region having an area at a predetermined ratio or lower with respect to the size of a prediction region PA, for example. A minute prediction region PA may be a prediction region PA having a predetermined area or smaller, or may be a prediction region PA having an area at a predetermined ratio or lower with respect to the area of a non-prediction region, for example.

Specifically, in a case where a minute non-prediction region is shown in a prediction region PA indicated by the prediction region information, the noise removal unit 451 transforms the minute non-prediction region into a prediction region PA. Likewise, in a case where a minute prediction region PA is shown in a non-prediction region indicated by the prediction region information, the noise removal unit 451 transforms the minute prediction region PA into a non-prediction region.

The closing processing unit 452 performs a closing process for interpolating prediction regions in a binarized image indicating prediction region information. The closing processing unit 452 may perform a closing process on the binarized image indicating the prediction region information received as an input by the input unit 41. Also, a closing processing may be performed on a binarized image indicating the prediction region information from which noise has been removed by the noise removal unit 451.

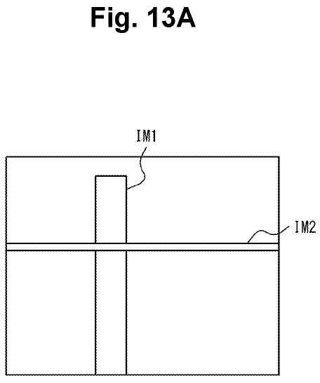

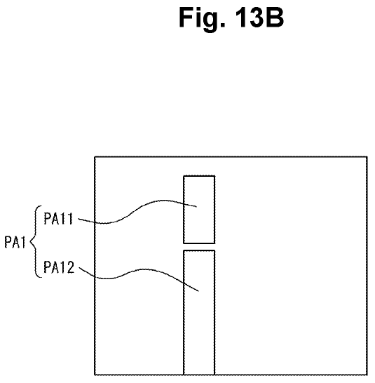

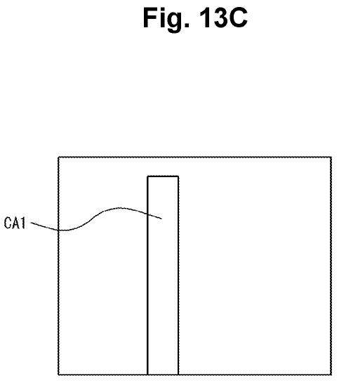

A closing process can be a process of performing expansion and contraction in morphological transform. A closing process is now described with reference to FIGS. 13A, 13B, and 13C. In an example illustrated in FIG. 13A, a first subject and a second subject are disposed within the imaging range of a camera in the real space, and the second subject is disposed in front of the first subject with respect to the camera. In such an example, as illustrated in FIG. 13A, an entire image IM2 of the second subject is shown in a captured image acquired by the image acquisition device 1, while only a portion of an image IM1 of the first subject is shown in a divided manner.

As illustrated in FIG. 13B, the image analysis device 3 detects, from the captured image illustrated in FIG. 13A, a prediction region PA11 that is a region in which a portion of the image IM1 of the first subject is present, and a prediction region PA12 that is a region in which another portion of the image IM1 is present. That is, a prediction region PA1 corresponding to the image IM1 of the first subject is divided into the prediction region PA11 and the prediction region PA12, and is then detected. As described above, since the first subject in the real space is not divided, the prediction region PA11 and the prediction region PA12 in the divided state are not in an appropriate state.

Therefore, the closing processing unit 452 interpolates a plurality of divided regions, to generate a closing prediction region CA1 corresponding to the first subject in the real space. In the example illustrated in FIG. 13B, the closing processing unit 452 interpolates the prediction region PA11 and the prediction region PA12, to generate the closing prediction region CA1 including the prediction region PA11, the prediction region PA12, and the interpolated region, as illustrated in FIG. 13C.

The edge processing unit 453 detects the edges of the prediction region PA by performing edge processing on the contours of the closing prediction region CA1 generated by the closing processing unit 452. The edge processing unit 453 may detect the edges of the prediction region PA indicated by the prediction region information received as an input by the input unit 41, or may detect the edges of the prediction region PA indicated by the prediction region information from which noise has been removed by the noise removal unit 451. As a result, erroneous detection is reduced in the subsequent detection of possible line segments LN by the line segment extraction unit 42. Thus, line segments indicating the contours of subjects in the real space with higher accuracy are extracted.

In the second embodiment, the line segment extraction unit 42 may extract line segments on the basis of the contours of a prediction region PA indicated by prediction region information from which noise has been removed by the noise removal unit 451. The line segment extraction unit 42 may extract line segments on the basis of the contours of a closing prediction region CA on which a closing process has been performed by the closing processing unit 452. The line segment extraction unit 42 may also extract line segments constituting the contours of a prediction region PA, on the basis of edges detected by the edge processing unit 453.

### <Operation of the Region Correction Device>

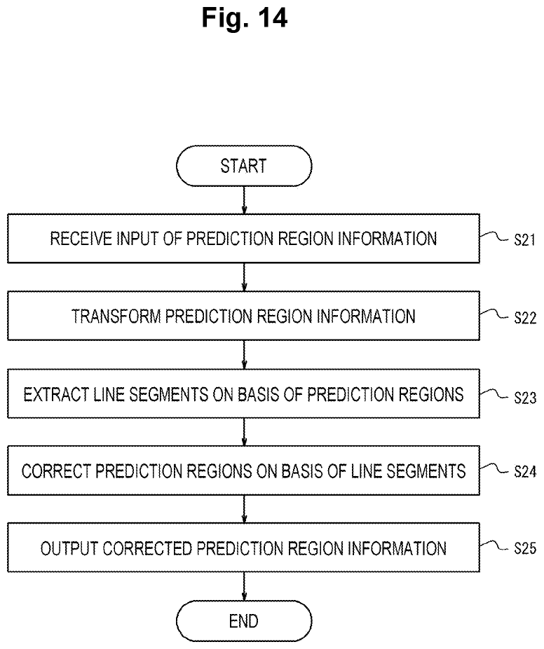

Here, an operation of the region correction device 4-1 according to the second embodiment is described with reference to FIG. 14. FIG. 14 is a flowchart illustrating an example operation of the region correction device 4-1 according to the second embodiment. The operation in the region correction device 4-1 to be described with reference to FIG. 14 corresponds to an example of a region correction method for the region correction device 4-1 according to the second embodiment.

In step S21, the input unit 41 receives an input of prediction region information output by the image analysis device 3.

In step S22, the prediction region information received as an input by the input unit 41 is transformed.

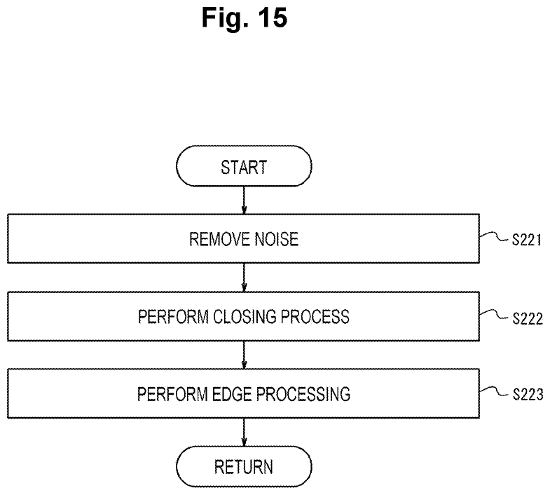

Here, the transform to be performed by the transform unit 45 in step S22 is described in detail, with reference to FIG. 15.

In step S221, the noise removal unit 451 removes noise included in the prediction region information.

In step S222, the closing processing unit 452 performs a closing process for interpolating the prediction regions in the binarized image indicated by the prediction region information from which noise has been removed by the noise removal unit 451.

In step S223, the edge processing unit 453 performs edge processing on the contours of the corrected prediction region generated by the closing processing unit 452.

Referring back to FIG. 14, in step S23, the line segment extraction unit 42 extracts line segments constituting at least a portion of the contours of the prediction regions PA indicated by the prediction region information, on the basis of the prediction region information transformed by the transform unit 45.

Subsequently, the region correction device 4-1 performs the processes in steps S24 and S25. The processes in steps S24 and S25 are the same as the processes in steps S13 and S14 in the first embodiment.

As described above, according to the second embodiment, the region correction device 4-1 further includes the noise removal unit 451 that removes noise included in prediction region information, and the correction unit 43 corrects the prediction regions PA indicated by the prediction region information from which noise has been removed. As a result, the region correction device 4-1 can reduce erroneous detection of line segments, and accordingly, can reduce erroneous transform in transforming peripheral pixels.

Also, according to the second embodiment, the region correction device 4-1 further includes the closing processing unit 452 that performs a closing process for interpolating the prediction regions in a binarized image indicating prediction region information, and the correction unit 43 corrects the prediction regions PA indicated by the prediction region information indicated by the binarized image on which the closing process has been performed. With this configuration, the region correction device 4-1 can reduce division of a prediction region PA indicating an image of a predetermined subject. Thus, the region correction device 4-1 can reduce extraction of a plurality of different line segments indicating a contour of an image due to division of a prediction region PA indicating am image of a predetermined subject, and can extract an undivided line segment indicating a contour of an image of a predetermined subject corresponding to the contour of the predetermined subject in the real space. Thus, the region correction device 4-1 can accurately detect the region of an image of an object in a captured image.

Note that, in the second embodiment, the transform unit 45 includes the noise removal unit 451, the closing processing unit 452, and the edge processing unit 453, but is not limited to this configuration. For example, the transform unit 45 may include at least one of the noise removal unit 451, the closing processing unit 452, and the edge processing unit 453.

### <Program>

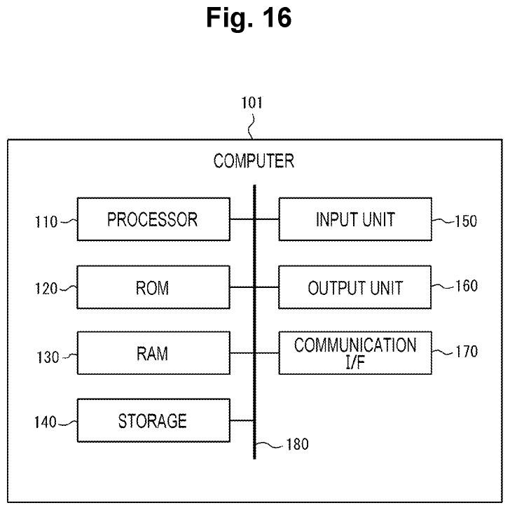

The region correction devices 4 and 4-1 described above can be implemented by a computer 101. Also, a program causing the region correction device 4 or 4-1 to function may be provided. Further, the program may be stored in a storage medium, or may be provided through a network. FIG. 16 is a block diagram illustrating a schematic configuration of the computer 101 that functions as the region correction device 4 or 4-1. Here, the computer 101 may be a general-purpose computer, a dedicated computer, a workstation, a personal computer (PC), an electronic notepad, or the like. A program instruction may be a program code, a code segment, or the like for executing required tasks.

As illustrated in FIG. 16, the computer 101 includes a processor 110, a read only memory (ROM) 120, a random access memory (RAM) 130, a storage 140, an input unit 150, a display unit 160, and a communication interface (I/F) 170. The respective components are communicably connected to one another via a bus 180. Specifically, the processor 110 is a central processing unit (CPU), a micro processing unit (MPU), a graphics processing unit (GPU), a digital signal processor (DSP), a system on a chip (SoC), or the like, and may be formed with the same or different types of processors.

The processor 110 performs control on the respective components and various kinds of arithmetic processing. That is, the processor 110 reads a program from the ROM 120 or the storage 140, and executes the program, using the RAM 130 as a work area. In accordance with a program stored in the ROM 120 or the storage 140, the processor 110 controls the respective components described above and performs various kinds of arithmetic processing. In the embodiments described above, a program according to the present disclosure is stored in the ROM 120 or the storage 140.

The program may be stored in a storage medium that can be read by the computer 101. When such a storage medium is used, the program can be installed into the computer 101. Here, the storage medium in which the program is stored may be a non-transitory storage medium. The non-transitory storage medium is not limited to any particular one, but may be a CD-ROM, a DVD-ROM, a universal serial bus (USB) memory, or the like, for example. Alternatively, the program may be downloaded from an external device via a network.

The ROM 120 stores various programs and various kinds of data. The RAM 130 temporarily stores a program or data, serving as a work area. The storage 140 is formed with a hard disk drive (HDD) or a solid state drive (SSD), and stores various programs including an operating system and various kinds of data.

The input unit 150 includes one or more input interfaces that receive a user's input operation and acquire information based on the user's operation. For example, the input unit 150 is a pointing device, a keyboard, a mouse, or the like, but is not limited to these.

The display unit 160 includes one or more output interfaces that output information. For example, the display unit 160 is a display that outputs information as a video image or a speaker that outputs information as sound, but is not limited to these. Note that, in a case where the display unit 160 is a touch panel display, the display unit 160 also functions as the input unit 150.

The communication interface (I/F) 170 is an interface for communicating with an external device.

Regarding the above embodiments, the following supplementary notes are further disclosed herein.

### (Supplemental Note 1)

A region correction device including:
an input interface that receives an input of prediction region information indicating a prediction region indicating an image of a predetermined subject, the prediction region being detected from a captured image obtained by imaging the predetermined subject; a controller; and an output interface,
in which
the controller
extracts a line segment on the basis of a contour of the prediction region indicated by the prediction region information, and
corrects the prediction region on the basis of the line segment, and
the output interface outputs corrected prediction region information indicating a corrected prediction region, the corrected prediction region being the prediction region that has been corrected.

### (Supplemental Note 2)

The region correction device according to supplemental note 1, in which
the prediction region information is a binarized image including pixels determined to be either a prediction pixel included in the prediction region or a non-prediction pixel included in a non-prediction region that is not the prediction region, and
the controller corrects the binarized image, on the basis of positions of a line segment pixel indicating the line segment, and the prediction pixel and the non-prediction pixel.

### (Supplemental Note 3)

The region correction device according to supplemental note 2, in which
the controller
moves a predetermined number of peripheral pixels in a direction orthogonal to a predetermined direction so that the line segment pixels are aligned in a line in the predetermined direction, the peripheral pixels being located adjacent to the line segment pixels in the orthogonal direction, and
corrects the binarized image by redetermining whether the peripheral pixels are the prediction pixels or the non-prediction pixels, on the basis of the number of the prediction pixels and the number of the non-prediction pixels constituting the peripheral pixels.

### (Supplemental Note 4)

The region correction device according to any one of supplemental notes 1 to 3, in which the controller extracts a plurality of possible line segments on the basis of the contour, and extracts the line segment from the plurality of possible line segment on the basis of at least one of a distance to another possible line segment from each possible line segment of the plurality of possible line segments, a length of each possible line segment of the plurality of possible line segments, an extending direction of each possible line segment of the plurality of possible line segments, and presence or absence of an intersection between each possible line segment of the plurality of possible line segments and another possible line segment.

### (Supplemental Note 5)

The region correction device according to any one of supplemental notes 1 to 4, in which
the controller
removes noise included in the prediction region information, and
extracts the line segment on the basis of the prediction region indicated by the prediction region information from which the noise has been removed.

### (Supplemental Note 6)

The region correction device according to any one of supplemental notes 1 to 4, in which
the controller
performs a closing process for interpolating the prediction region in a binarized image that is the prediction region information, and
extracts the line segment on the basis of the prediction region indicated by the binarized image on which the closing process has been performed.

### (Supplemental Note 7)

A region correction method including:
a step of receiving an input of prediction region information indicating a prediction region indicating an image of a predetermined subject, the prediction region being detected from a captured image obtained by imaging the predetermined subject;
a step of extracting a line segment on the basis of a contour of the prediction region indicated by the prediction region information;
a step of correcting the prediction region on the basis of the line segment; and
a step of outputting corrected prediction region information indicating a corrected prediction region obtained by correcting the prediction region.

### (Supplemental Note 8)

A non-transitory storage medium storing a program that can be executed by a computer, the non-transitory storage medium causing the computer to function as the region correction device according to any one of supplemental notes 1 to 6.

All the literatures, patent applications, and technical standards mentioned in this specification are incorporated herein by reference to the same extent as if each individual literature, patent application, and technical standard were specifically and individually described to be incorporated by reference.

Although the above embodiments have been described as representative examples, it is apparent to those skilled in the art that many modifications and substitutions can be made within the spirit and scope of the present disclosure. Accordingly, it should not be understood that the present invention is limited by the above embodiments, and various modifications or changes can be made within the scope of the claims. For example, a plurality of configuration blocks illustrated in the configuration diagrams of the embodiments can be combined into one, or one configuration block can be divided.

### REFERENCE SIGNS LIST

1 image acquisition device
2 image saving device
3 Image analysis device
4, 4-1 region correction device
5 data storage device
41 input unit
42 line segment extraction unit
43 correction unit
44 output unit
45 transform unit
100, 100-1 region correction system
101 computer
110 processor
120 ROM
130 RAM
140 storage
150 input unit
160 output unit
170 communication interface
180 bus
421 detection unit
422 extraction unit
431 peripheral pixel determination unit
432 peripheral pixel storage unit
433 peripheral pixel transform unit
451 noise removal unit
452 closing processing unit
453 edge processing unit

1. The region correction device comprising:
receiving an input of prediction region information indicating a prediction region indicating an image of a predetermined subject, the prediction region being detected from a captured image obtained by imaging the predetermined subject;
extracting a line segment corresponding to a contour of the predetermined subject, on a basis of a contour of the prediction region indicated by the prediction region information;
correcting the prediction region on a basis of the line segment; and
output corrected prediction region information indicating a corrected prediction region, the corrected prediction region being the prediction region that has been corrected.

2. The region correction device according to claim 1, wherein
the prediction region information is a binarized image including pixels determined to be one of a prediction pixel included in the prediction region or a non-prediction pixel included in a non-prediction region that is not the prediction region, and
the binarized image is corrected, on a basis of positions of a line segment pixel indicating the line segment, and the prediction pixel and the non-prediction pixel.

3. The region correction device according to claim 2, wherein
a predetermined number of peripheral pixels is moved in a direction orthogonal to a predetermined direction so that the line segment pixels are aligned in a line in the predetermined direction, the peripheral pixels being located adjacent to the line segment pixels in the orthogonal direction, and
corrects the binarized image by redetermining whether the peripheral pixels are the prediction pixels or the non-prediction pixels, on a basis of the number of the prediction pixels and the number of the non-prediction pixels constituting the peripheral pixels.

4. The region correction device according to claim 1, wherein a plurality of possible line segments is extracted on a basis of the contour, and extracts the line segment from the plurality of possible line segment on a basis of at least one of a distance to another possible line segment from each possible line segment of the plurality of possible line segments, a length of each possible line segment of the plurality of possible line segments, an extending direction of each possible line segment of the plurality of possible line segments, and presence or absence of an intersection between each possible line segment of the plurality of possible line segments and another possible line segment.

5. The region correction device according to claim 1, further comprising:
removing noise included in the prediction region information,
wherein the line segment is extracted on a basis of the prediction region indicated by the prediction region information from which the noise has been removed.

6. The region correction device according to claim 1, further comprising:
performing a closing process for interpolating the prediction region in a binarized image that is the prediction region information,
wherein the line segment is extracted on a basis of the prediction region indicated by the binarized image on which the closing process has been performed.

7. A region correction method comprising:
receiving an input of prediction region information indicating a prediction region indicating an image of a predetermined subject, the prediction region being detected from a captured image obtained by imaging the predetermined subject;
extracting a line segment corresponding to a contour of the predetermined subject, on a basis of a contour of the prediction region indicated by the prediction region information;
correcting the prediction region on a basis of the line segment; and
outputting corrected prediction region information indicating a corrected prediction region obtained by correcting the prediction region.

8. (canceled)

9. The region correction device method to claim 7, wherein
determining the prediction region information in a binarized image including pixels to be one of a prediction pixel included in the prediction region or a non-prediction pixel included in a non-prediction region that is not the prediction region, and
correcting the binarized image, on a basis of positions of a line segment pixel indicating the line segment, and the prediction pixel and the non-prediction pixel.

10. The region correction method according to claim 9, wherein
moving a predetermined number of peripheral pixels in a direction orthogonal to a predetermined direction so that the line segment pixels are aligned in a line in the predetermined direction, the peripheral pixels being located adjacent to the line segment pixels in the orthogonal direction, and
correcting the binarized image by redetermining whether the peripheral pixels are the prediction pixels or the non-prediction pixels, on a basis of the number of the prediction pixels and the number of the non-prediction pixels constituting the peripheral pixels.

11. The region correction method according to claim 7, further comprising:
extracting a plurality of possible line segments on a basis of the contour, and extracts the line segment from the plurality of possible line segment on a basis of at least one of a distance to another possible line segment from each possible line segment of the plurality of possible line segments, a length of each possible line segment of the plurality of possible line segments, an extending direction of each possible line segment of the plurality of possible line segments, and presence or absence of an intersection between each possible line segment of the plurality of possible line segments and another possible line segment.

12. The region correction method according to claim 7, further comprising:
removing noise included in the prediction region information; and
extracting the line segment on a basis of the prediction region indicated by the prediction region information from which the noise has been removed.

13. The region correction method according to claim 7, further comprising:
performing a closing process for interpolating the prediction region in a binarized image that is the prediction region information; and
extracting the line segment on a basis of the prediction region indicated by the binarized image on which the closing process has been performed.

14. A computer-implemented method for region correction, the method comprising:
receiving an input of prediction region information indicating a prediction region indicating an image of a predetermined subject, the prediction region being detected from a captured image obtained by imaging the predetermined subject;
extracting a line segment corresponding to a contour of the predetermined subject, on a basis of a contour of the prediction region indicated by the prediction region information;
correcting the prediction region on a basis of the line segment; and
output corrected prediction region information indicating a corrected prediction region, the corrected prediction region being the prediction region that has been corrected. generating one or more suggested responses to the predicted first subsequent query and the second subsequent query.

15. The method for region correction according to claim 14, wherein
determining the prediction region information in a binarized image including pixels to be one of a prediction pixel included in the prediction region or a non-prediction pixel included in a non-prediction region that is not the prediction region, and
correcting the binarized image, on a basis of positions of a line segment pixel indicating the line segment, and the prediction pixel and the non-prediction pixel.

16. The method for region correction according to claim 15, wherein
moving a predetermined number of peripheral pixels in a direction orthogonal to a predetermined direction so that the line segment pixels are aligned in a line in the predetermined direction, the peripheral pixels being located adjacent to the line segment pixels in the orthogonal direction, and
correcting the binarized image by redetermining whether the peripheral pixels are the prediction pixels or the non-prediction pixels, on a basis of the number of the prediction pixels and the number of the non-prediction pixels constituting the peripheral pixels.

17. The method for region correction according to claim 14, further comprising:
extracting a plurality of possible line segments on a basis of the contour, and extracts the line segment from the plurality of possible line segment on a basis of at least one of a distance to another possible line segment from each possible line segment of the plurality of possible line segments, a length of each possible line segment of the plurality of possible line segments, an extending direction of each possible line segment of the plurality of possible line segments, and presence or absence of an intersection between each possible line segment of the plurality of possible line segments and another possible line segment.

18. The method for region correction according to claim 14, further comprising:
removing noise included in the prediction region information; and
extracting the line segment on a basis of the prediction region indicated by the prediction region information from which the noise has been removed.

19. The method for region correction according to claim 14, further comprising:
performing a closing process for interpolating the prediction region in a binarized image that is the prediction region information; and
extracting the line segment on a basis of the prediction region indicated by the binarized image on which the closing process has been performed.
